(19) United States
(12) Patent Application Publication
(10) Pub. No.: US 2017/0371854 A1
(43) Pub. Date: Dec. 28, 2017

(54) CONSISTENT RESOURCE MANAGEMENT AND VERSION MANAGEMENT SERVICE BASED ON FORMAL CERTIFICATION

(71) Applicant: Xerox Corporation, Norwalk, CT (US)

(72) Inventors: Jean-Yves Vion-Dury, Biviers (FR); Nikolaos Lagos, Grenoble (FR); Jean-Pierre Chanod, Grenoble (FR)

(73) Assignee: Xerox Corporation, Norwalk, CT (US)

(21) Appl. No.: 15/193,682

(22) Filed: Jun. 27, 2016

(51) Int. Cl. G06F 17/22; G06F 17/24

(52) U.S. Cl. CPC G06F 17/2288; G06F 17/2205; G06F 17/24

(57) ABSTRACT

A Version management Service (VMS) that enables consistent management of dynamic digital resources throughout their life cycle. The service handles the association of resources with logical specifications formally expressed using an extensible logical language understood and agreed by tiers. A new version of a digital resource is considered certified only if the resource owner is able to formally prove that the new version satisfies the logical specifications, with the help of the VMS. The VMS uses formal proofs for qualifying changes (occurring either on the resource content or on the corresponding specifications), and for characterizing them through the evolution of version labels. While the resource owners may handle a fully detailed specification (internal), the users may have a simplified view of the same resource, i.e. a particular external specification.

### BACKGROUND

The subject disclosure is directed to the computer arts, computer network arts, device management arts, software version management arts, and the like.

Versioning is particularly challenging in dynamic, non-centralized architectures, as it is much more difficult to propagate changes in a consistent manner requiring strict coordination of tiers. Such a case is for example service-oriented architectures, where in addition, the separation of the service interface from its implementation, which is often referred to as opacity, is an additional complexity (changes in either the interface or the implementation may have an impact on the contract that the service provider has with a consumer from a functional or quality-of-service (QoS) point). See, e.g., M. Novakouski, G. Lewis, W. Anderson and J. Davenport. “Best Practices for Artifact Versioning in Service-Oriented Systems,” Software Engineering Institute, Carnegie Mellon University, Pittsburgh, Pa., Technical Note CMU/SEI-2011-TN-009, 2012, the entire disclosure of which is incorporated by reference herein.

In some implementations, versioning support has two dimensions (adapted from Novakouski et al.), e.g., interface verisioning and implementation versioning.

Interface versioning corresponds to versioning support for the description of the behaviour that is expected by clients of a system, e.g. this could be the artifacts that describe the interaction of the service with its environment (for instance definitions of data types in XML Schema and WSDL and Abstract BPEL documents in the case of service-environment).
Implementation versioning, in contrast, corresponds to versioning support for the code, resources, configuration files and documentation of a system.

While traditional Software Configuration Management (SCM) systems, such as the version control systems Subversion by the Apache Software Foundation, and the more modern GIT available from the Software Freedom Conservancy (among others), are being used for implementation versioning, interface versioning is still a not very-well studied subject.

Change management includes defining strategies for: version naming (which should aid in recording the continuous process of service development); and for identifying/responding to different change types (which should be related to controlling the consistency of different versions). A system and method for responding to both these above-identified issues and integrating such a response into a single framework is needed.

Version naming is most typically designed to reflect consumer compatible and non-compatible (or breaking and non-breaking) changes. The former constitute major releases and the latter minor ones. The corresponding naming usually follows the “Major#.Minor#” scheme where the sequential major release version number precedes the minor one. See, e.g., K. Jerijrvi and J.-J. Dubray, “Contract Versioning, Compatibility and Composability,” InfoQ Magazine, December 2008, the entire disclosure of which is incorporated by reference herein. Alternatively naming schemes may incorporate a time-stamp instead of the above identifier. However, the above naming schemes provide very limited semantic information about the position of the versions in the version graph, which represents the relationships between versions. See, e.g., Conradi and B. Westfechtel. “Version models for software configuration management.” ACM Comput. Surv. 30, 2 (June 1998), pages 232-282, the entire disclosure of which is incorporated by reference herein. Recent approaches, especially in the area of web services, have tried to overcome this. For instance, M. B. Juric, A. Sasa, B. Brumen and I. Rozman, “WSDL and UDDI extensions for version support in web services.” Journal of Systems and Software, Volume 82, Issue 8, August 2009, pp. 1326-1343, ISSN 0164-1212 [the entire disclosure of which is incorporated by reference herein] extends WSDL and UDDI with custom meta-data. Accordingly, what is needed is a system and method for semantic versioning that carries explicit semantics in the naming, so part of the version graph can be reconstructed by using only the version labels.

Previous attempts to create such a system that have proposed the enrichment of the version labels with well-defined semantic information. For instance, the work of Curtis Wetherly, Bryan R. Goring, Michael Shenfield, Michael Cacenco. System and method for implementing data-compatibility-based version scheme, U.S. Pat. No. 8,555,272, and Cacenco, M. and Goring, B. and Shenfield, M. and Wetherly, C. Implementing data-compatibility-based version scheme, WO Patent App. PCT/CA2005/001345, the entire disclosures of which are incorporated by reference herein, proposes using a three-label version scheme as well, where each label is incremented in response to changes in the versioned resource (in their case each label corresponds to one of data components, message components and features). Vairavan, V. and Bellur, U. Method and system for versioning a software system. U.S. patent application Ser. No. 12/324,950, the entire disclosure of which is incorporated by reference herein, goes one step further by not only assigning semantics to version labels but also using them to determine the compatibility between entities (e.g. UML processes) and source code modules. However, in all previous works the formal grounding is not delineated. Furthermore, the naming scheme is defined by the provider and it is the job of the consumers to use this consistently. The systems and methods set forth in the subject disclosure allow separate identifiers for the service owner/provider and each of the users(s)/consumer(s). It is the job of the VMS to ensure the consistency of the mapping between them.

M. P. Papazoglou, S. Benbernou, V. Andrikopoulos, “On the Evolution of Services,” IEEE Transactions on Software Engineering, vol. 38, no. 3, pp. 609-628, May-June, 2012, the entire disclosure of which is incorporated by reference herein, provides a theoretical type-safe framework is proposed to ensure correct versioning transitions in service-oriented environments. Although the method set forth in Papazoglou et al. sketches the relation between the notion of compatibility and specifications, it does do not provide any formal grounding on how the modelling of consistent change is reflected by the naming scheme of different variants. In addition, Papazoglou et al. does not refer at all to the notion of a dedicated management versioning service but rather concentrates on a direct versioning approach. In direct versioning approaches, the end-user (e.g., the consumer) and provider are directly connected and each one has to manage changes to their requirements and offer respectively. Furthermore, Papazoglou et al. does not formalize the evolution of artifacts in highly dynamic environments. Accordingly, what is needed is an intermediary-based approach utilizing a management service between the end-user and the provider. Finally Papazoglou et al. does not delineate any clear separation of the versioning and the rest of the infrastructure.

Versioning concerns in the realm of components has been attempted, although substantially different from the needed services versioning. See, e.g., P. Brada. “Specification-Based Component Substitutability and Revision Identification.” PhD thesis, Charles University, Prague, August 2003, the entire disclosure of which is incorporated by reference herein. Brada formalises the notion of component versioning to support consistent substitutability of components and falls under the umbrella of software configuration management for component-based systems. Brada, however, is mainly focused on a specific architecture (widely used for software components) called CORBA. This component-based environment is substantially different from the requirements of service-oriented environments. Furthermore, Brada does not reference or suggest a dedicated versioning service.

Accordingly, what is needed are systems and methods for addressing the above-identified issues and failings via a service-based version management service.

### INCORPORATION BY REFERENCE

Semantic Versioning, Technical Whitepaper, OSGi Alliance, Revision 1.0, May 2010, http://www.osgi.org, last accessed: [Apr. 6, 2014]
M. Novakouski, G. Lewis, W. Anderson and J. Davenport. “Best Practices for Artifact Versioning in Service-Oriented Systems,” Software Engineering Institute, Carnegie Mellon University, Pittsburgh, Pa., Technical Note CMU/SEI-2011-TN-009, 2012. http://resources.sei.cmu.edu/asset_files/TechnicalNote/2012_004_001_15356. pdf last accessed: [Apr. 6, 2014]
K. Jerijrvi and J.-J. Dubray, “Contract Versioning, Compatibility and Composability,” InfoQ Magazine, December 2008; www.infoq.com/articlescontract-versioning-comp2 last accessed: [Apr. 6, 2014]
R. Conradi and B. Westfechtel. “Version models for software configuration management.” ACM Comput. Surv. 30, 2 (June 1998), 232-282. DOI=10.1145/280277.280280 http://doi.acm.org/10.1145/280277.280280
M. B. Juric, A. Sasa, B. Brumen and I. Rozman, “WSDL and UDDI extensions for version support in web services.” Journal of Systems and Software, Volume 82, Issue 8, August 2009, pp. 1326-1343, ISSN 0164-1212, http://dx.doi.org/10.1016/j.jss.2009.03.001. http://www.sciencedirect.com/science/article/pii/S0164121209000478 last accessed: [Apr. 6, 2014]
M. P. Papazoglou, S. Benbernou, V. Andrikopoulos, “On the Evolution of Services,” IEEE Transactions on Software Engineering, vol. 38, no. 3, pp. 609-628, May-June, 2012—preprint, http://infolab.uvt.nl/˜mikep/publications/IEEE-TSE%20%5Bpreprint%5D.pdf last accessed: [Apr. 6, 2014]
Leitner, P.; Michlmayr, A.; Rosenberg, F.; Dustdar, S., “End-to-End Versioning Support for Web Services,” Services Computing, 2008. SCC '08. IEEE International Conference on, vol. 1, no., pp. 59-66, July 2008—Technical report version doi: 10.1109/SCC.2008.21 http://www.infosys.tuwien.ac.at/staff/leitner/papers/TUV-1841-2008-1.pdf last accessed: [Apr. 6, 2014]
P. Brada. “Specification-Based Component Substitutability and Revision Identification.” PhD thesis, Charles University, Prague, August 2003, http://d3s.mff.cuni.cz/publications/download/brada_phd.pdf last accessed: [Apr. 6, 2014]
C. Schaale. “Cloud Service Brokerage: a policy-based business model.” Internet policy review: Journal on Internet Regulation. November 2013. http://policyreview.info/taQgscloud-services last accessed: [Jan. 7, 2014]
N. G. De Bruijn. “On the roles of types in mathematics.” The Curry-Howard isomorphism, 1995, vol. 8, pp. 27-54.
T. Cocquand and G. Huet. “The Calculus of Constructions.” INRIA Research Report RR-0530, May 1986.
M. Boespflug, Q. Carbonneaux and O. Hermant, “The lambda-Pi-calculus Modulo as a Universal Proof Language.” In PxTP 2012.
R. Saillard. “Dedukti: a universal proof checker.” In: Foundation of Mathematics for Computer-Aided Formalization Workshop. 2013.
T. Nipkow, L. C. Paulson and M. Wenzel (ed.). “Isabelle/HOL: a proof assistant for higher-order logic.” Springer, 2002.
Laboreo, Daniel Clemente. Introduction to Natural Deduction. Tutorial, May 2005. http://www.danielclemente.com/logica/dn.en.pdf.
F. Kirchner and C. Mufoz. “The Proof Monad.” The Journal of Logic and Algebraic Programming 79.3 (2010): 264-277.
CORBA 3.3. Accessed Jun. 26, 2014. http://www.omg.ori/spec/CORBA/3.3/.
J. Hurd. The OpenTheory Standard Theory Library. In NASA Formal Methods, 17791. Springer, 2011.
Curtis Wetherly, Bryan R. Goring, Michael Shenfield, Michael Cacenco. System and method for implementing data-compatibility-based version scheme, U.S. Pat. No. 8,555,272. 2013.
Cacenco, M. and Goring, B. and Shenfield, M. and Wetherly, C. Implementing data-compatibility-based version scheme, WO Patent App. PCT/CA2005/001,345, 2006.
Vairavan, V. and Bellur, U. Method and system for versioning a software system. U.S. patent application Ser. No. 12/324,950, 2009.
Castagna, G., Gesbert, N., and Padovani, L. A Theory of Contracts for Web Services. In Proceedings of the 35^{th} Annual ACM SIGPLAN-SIGACT Symposium on Principles of Programming Languages, 26172. POPL 08. New York, N.Y., USA: ACM, 2008. doi:10.1145/1328438.1328471. http://eprints.gla.ac.uk/47889.
Bocchi, L., Honda, K., Tuosto, E., and Yoshida, N. A Theory of Design-by-Contract for Distributed Multiparty Interactions. In CONCUR 2010-Concurrency Theory, edited by Paul Gastin and Franois Laroussinie, 16276. Lecture Notes in Computer Science 6269. Springer Berlin Heidelberg. http://www.cs.le.ac.uk/people/lb48/AssertedTypes/assertedTypesExtended.pdf
The disclosures of which are incorporated herein by reference in their entirety.

### BRIEF DESCRIPTION

In one embodiment of this disclosure, described is a method for version management of a resource. The method includes receiving, from a resource owner, a resource certification request, the resource certification request comprising a resource and a specification corresponding thereto, and determining a version of the resource in accordance with at least one of the corresponding specification and an invariant associated with the resource. The method further includes generating a label for the resource in accordance with the determined version and at least one of the corresponding specification and the invariant associated with the resource, and certifying the resource in accordance with the corresponding specification. Additionally, the method includes publishing the certified resource to an associated registry, wherein at least one of the receiving, determining, generating, certifying, and publishing is performed by a computer processor in communication with memory.

In another embodiment of this disclosure, described is a system for version management of a resource. The system includes a server having a processor and memory in communication with the processor, and a data storage in communication with the processor, the data storage storing a registry of certified resources. The memory stores instructions which are executed by the processor to receive, from a resource owner over a network interface, a resource certification request, the resource certification request comprising a resource and a specification corresponding thereto, and to store the resource and the corresponding specification in the data storage. The memory also stores instructions to determine a version of the resource in accordance with at least one of the corresponding specification and an invariant associated with the resource, and to generate a label for the resource in accordance with the determined version and at least one of the corresponding specification and the invariant associated with the resource. The memory further stores instructions which are executed by the processor to certify the resource in accordance with the corresponding specification, and to publish the certified resource to an associated registry.

In still another embodiment of this disclosure, described is a computer-implemented method for managing a version of a resource. The computer-implemented method includes receiving, from a resource owner, a resource certification request, the resource certification request comprising a resource and a specification corresponding thereto, and determining a version of the resource in accordance with at least one of the corresponding specification and an invariant associated with the resource. The computer-implemented method further includes determining a revision of the resource from the group consisting of a major revision, a minor revision, or a micro revision, wherein the version of the resource is updated in accordance with the determined revision, and generating a label for the resource in accordance with the determined version and revision, and at least one of the corresponding specification and the invariant associated with the resource. In addition, the computer-implemented method includes determining whether the resource satisfies the specification, certifying the resource in accordance with a determination that the resource satisfies the corresponding specification, and publishing the certified resource to an associated registry.

### BRIEF DESCRIPTION OF THE DRAWINGS

FIG. 1 illustrates a functional block diagram of a versioning management system in accordance with one embodiment of the subject disclosure.

FIG. 2 illustrates a versioning process in accordance with one embodiment of the subject disclosure.

FIG. 3 illustrates a co-evolution of versions opaque to the client in accordance with one embodiment of the subject disclosure.

FIG. 4 illustrates a co-evolution of versions perceived by the client as having micro effects in accordance with one embodiment of the subject disclosure.

FIG. 5 illustrates a co-evolution of versions perceived by the client as having minor effects in accordance with one embodiment of the subject disclosure.

FIG. 6 illustrates a co-evolution of versions perceived by the client as having major effects in accordance with one embodiment of the subject disclosure.

FIG. 7 illustrates a diagram depicting the impact of micro changes in versions with a static external specification in accordance with one embodiment of the subject disclosure.

FIG. 8 illustrates a diagram depicting the impact of micro changes in versions with a varying external specification in accordance with one embodiment of the subject disclosure.

FIG. 9 is a graphical depiction of the impact of minor changes in versions in accordance with one embodiment of the subject disclosure.

FIG. 10 is a graphical depiction of the impact of major changes in versions in accordance with one embodiment of the subject disclosure.

FIG. 11 is an illustration a table including operations and corresponding impact on version labels in accordance with one embodiment of the subject disclosure.

FIG. 12 is an illustration diagrammatically depicting the certification of the evolution of a resource according to a specification in accordance with one embodiment of the subject disclosure.

FIG. 13 is a flow chart representative of a method for versioning management in accordance with one embodiment of the subject disclosure.

FIG. 14 is a higher order intuitionistic logic [symbol] used in one embodiment of the subject disclosure.

FIG. 15 is a proof system for use in one embodiment of the disclosure.

### DETAILED DESCRIPTION

One or more embodiments will now be described with reference to the attached drawings, wherein like reference numerals are used to refer to like elements throughout. Aspects of exemplary embodiments related to systems and methods for re-ranking trips on an associated transportation network are described herein. In addition, example embodiments are presented hereinafter referring to travel planning on transportation networks, however application of the systems and methods set forth can be made to other areas utilizing “crowd-wisdom” recommendations.

The subject disclosure describes a Version Management Service (VMS) that may be deployed in constantly evolving, non-centralised environments, e.g., document management systems, operating systems, computer programs, file management systems, and the like. The VMS enables consistent management of dynamic digital resources throughout their life cycle for the benefit of both data owner/provider (the entities offering the resource) and data users (the entities using the resources).

In accordance with one embodiment, the VMS manages the association of resources with logical specifications written in an extensible logical formalism understood and agreed by tiers. As used herein, specifications describe the structure, behavior and more generally the logical properties of the associated resource including, for instance, hypotheses regarding the usage context. When the resource owner is able to formally prove that the resource does satisfy the specification, with the help of the VMS, the particular resource becomes certified.

In such an embodiment, the process entails benefits for both the resource users and owners. The resource users have a strong guarantee with respect to the versioning of certified resources. More specifically, the resource users gain knowledge that the versioning scheme always reflects the evolution of the resources for which they contracted (e.g., purchased, installed, etc.) in a consistent way. Additionally, the resource owner, receives valuable support from the users to manage the coherence between versions while minimizing the requested proofs at each step. The VMS also verifies the well-formedness of proofs and properties when required, so that the version labels stay consistent. Accordingly, the VMS formally checks that, at any stage, both the specifications and the satisfaction proofs are well-formed. The present embodiments identify all evolution cases in order to characterize the changes and minimize the proof computations.

In accordance with another aspect of the subject disclosure, an intermediary-based approach is provided wherein an end-user (e.g., consumer, author, device user, musician, etc.), never communicates with a services provider directly but only through a third service (i.e. a versioning management service). The versioning management service is responsible of managing the changes happening to any of the connected services and is the preferred method in the context of service-oriented environments. See, e.g., Leitner, P.; Michlmayr, A.; Rosenberg, F.; Dustdar, S., “End-to-End Versioning Support for Web Services,” Services Computing, 2008. SCC '08. IEEE International Conference on, vol. 1, no., pp. 59-66, July 2008, the entire disclosure of which is incorporated by reference herein.

It will be appreciated that the versioning management service of the present disclosure first utilizes certified version evolution and second utilizes the separation of the logical specification that formally characterizes the resource of the resource owner from the logical specification that formally characterizes the expected use of the resource of the resource user.

With respect to the use of certified version evolution, the certification provided by the VMS is representative of a guarantee that the expected good properties regarding the usage of digital resources are preserved. In addition, the impact of changes is faithfully reflected by the version labels managed by the VMS. This desirable property is the consequence of a rigorous versioning model, operated with the help of logical tools able to verify properties and build proofs. Hence, when the resource owner wants to register the evolution of a resource, or of its logical specifications, he is asked to provide proofs that the system is able to check for correctness. The internal logic of the VMS minimizes these proofs.

Regarding the separation of logical specifications, software engineering, for example, uses the term “contract” as representative of the logical specification that formally characterizes the resource of the resource owner, which is separate from the “contract” of the resource users (i.e., the logical specification that formally characterises the expected use of the resource). Currently, versioning is today associated with one unique central specification (API, contract, document) used by both the provider and the end-user/consumer of the resource. In contrast, the subject disclosure is configured to consider that a resource has one provider (or owner) responsible for its maintenance and evolution and possibly many users (or consumers) able to retrieve and download the resources based on a version label-based designation mechanism provided herein. Depending on their needs, users may have a more or less simplified view of the resource properties. It will be appreciated that such simplified views will require less effort regarding the certification of versions, and will tune the resource to the exact needs of the user, who consequently will be less exposed to incompatible changes. Based on this distinction, the VMS enables the resource owner to propagate rigorously the changes toward a coherent labeling scheme adapted to the various needs of its end-users (or consumers).

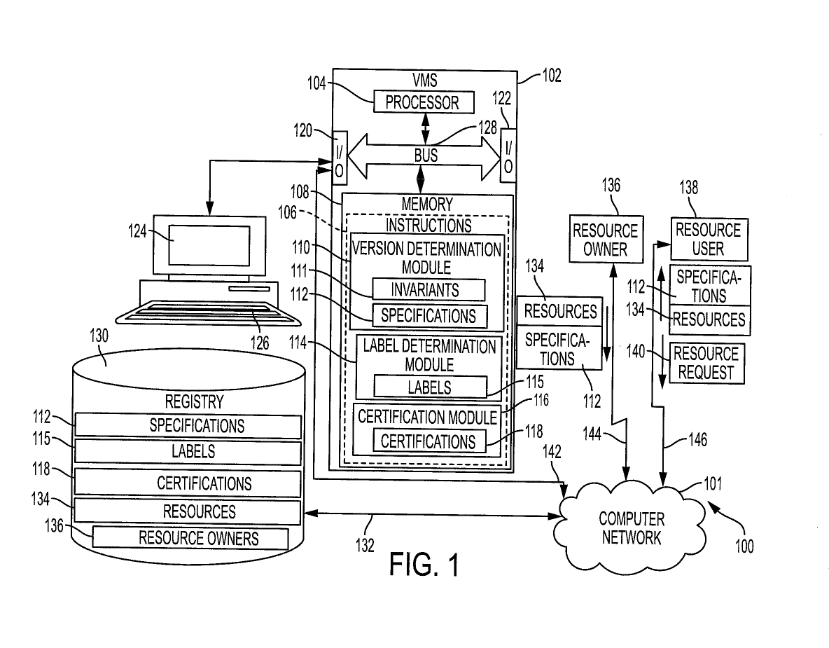

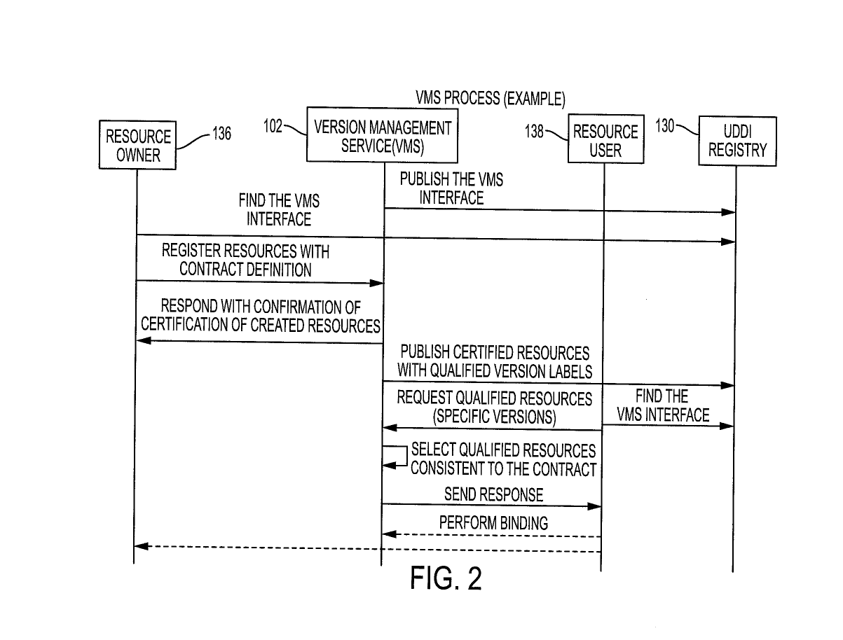

Referring now to FIG. 1, with reference to FIG. 2, there is shown a functional block diagram of a system for versioning management 100 in accordance with an example embodiment of the subject disclosure. It will be appreciated that the various components depicted in FIG. 1 is for purposes of illustrating aspects of the exemplary hardware, software, or a combination thereof, are capable of being substituted therein.

It will be appreciated that the system 100 of FIG. 1 is capable of implementation using a distributed computing environment, such as a computer network 101, which is representative of any distributed communications system capable of enabling the exchange of data between two or more electronic devices. It will be further appreciated that such a computer network 101 includes, for example and without limitation, a virtual local area network, a wide area network, a personal area network, a local area network, the Internet, an intranet, or the any suitable combination thereof. Accordingly, such a computer network comprises physical layers and transport layers, as illustrated by various conventional data transport mechanisms, such as, for example and without limitation, Token-Ring, Ethernet, or other wireless or wire-based data communication mechanisms. Furthermore, while depicted in FIG. 1 as a networked set of components, the system and method discussed hereinafter are capable of implementation on a stand-alone device adapted to perform the methods described herein.

As shown in FIG. 1, the system 100 includes a versioning management system (VMS) 102, which is capable of facilitating the implementation of the exemplary method described below. The VMS 102 may include a computer server, workstation, personal computer, laptop computer, cellular telephone, tablet computer, pager, combination thereof, or other computing device or group of networked devices capable of executing instructions for performing the exemplary method.

According to one example embodiment, the VMS 102 includes hardware, software, and/or any suitable combination thereof, configured to interact with an associated user, a networked device, networked storage, remote devices, or the like. The exemplary VMS 102 includes a processor 104, which performs the exemplary method by execution of processing instructions 106 which are stored in memory 108 connected to the processor 104, as well as controlling the overall operation of the computer system 102.

The instructions 106 include a version determination module 110 that determines the version of a resource 134 in accordance with any invariant 111 and/or specification 112 associated with the resource 134, as well as any preceding versions (if any) available to the VMS 102. In accordance with one embodiment, a resource r 134 is associated with its corresponding logical specification 112 enabling the VMS 102 to apply to both as a standalone entity. Furthermore, when the resource owner 136 creates a resource 134 using the VMS 102, the resource owner 136 must provide the VMS 102 with two logical formulae: the invariant 111 and the specification 112.

As used herein, the invariant 111 is the logical properties that the resource 134 must always satisfy during its life cycle, whereas the specification 112 is a logical formula that may change over time, but that the resource 134 must satisfy in order to be qualified/certified. The certification/qualification of a resource 134 in accordance with one embodiment of the subject disclosure is an operation under control of the VMS 102 that formally establishes the consistency of the resource 134 with its logical specification 112, and consequently, allows the version determination module 114 to generate a version increment. In some embodiments disclosed herein, the choice of the increment type is left to the resource owner 136, however such choice may be required to satisfy logical properties that may be verified by the VMS 102.

The invariant 111 is associated with a versioned resource 134 as it allows a resource owner 136, intending to derive versions, to preserve some aspect of the resource 134 that all variants of the resource 134 have in common. If this were not the intent, then new versions would not be required. Rather, the resource owner 136 would just need to derive a new resource 134 with a different name and different logical characteristics, and start a novel life cycle.

The specification 112 is representative of an abstract description that explains what the resource 134 is and how it can be used. For instance, this can be a document describing an API (Software Engineering and Service Oriented Architectures), it can be an SQL schema for a data set, a formal context free grammar for a source code written in a specific programming language, an XSD schema for an XML document, and so on. A specification 112 may also be used to describe tests that a resource should pass in order to be considered valid.

The VMS 102 may require such specification 112 to be formally expressed using the underlying logic [symbol] and a specific, owner designed, theory [symbol] that extends the core logic with axioms and theorems suitable to handle the owner's applicative domain. Such theories may be uploaded to the VMS 102, which in turn will check their correctness. Accordingly, the VMS 102 may require formal proofs to certify a versioning step. Such a proof will take the form of what is called a proof term, i.e a particular data structure that reflects exactly how the proof was constructed from the axioms and the theorem. Although it can be very hard to build a proof, it is very easy to verify that it is well-formed and that it is indeed a proof of the claimed property.

The instructions 106 stored in memory 108 further include a label determination module 114 that provides a label 115 identifying the resource 134 and version of the resource 134. In accordance with one embodiment, a resource r 134 represent a digital content (its digital extension as a bitstream) and is persistently stored in the service infrastructure, e.g., the VMS 102, the registry 130, the resource owner 136, etc., in association with a unique identifier, a version label 115 noted [M.m.μ:v]/s, where M,m,μ,v,s are natural numbers greater or equal to 0. The number M stands for major revision, m for minor, μ for micro, v for variant and s for stamp. Minor versions preserve the backward compatibility (while possibly offering new functionalities); micro versions have no visible impacts from the external specification point of view (improvements, bug fixes, simplifications . . . ); and major versions may require deeply revising the processes depending on the changing resource 134. It will be appreciated that such a scheme advantageously provides a straightforward way to communicate to the users 138 of a resource 134 whether its evolutions are backward compatible or incompatible.

The stamp is incremented at each modification operation, independently of versioning mechanisms. As a consequence, a resource 134 can be updated and never versioned, meaning that the changes can be tracked and memorized, but without any assumptions regarding its semantic properties. A resource r 134 is considered as certified/qualified when a versioning operation is able to logically establish its compliance with its semantic specification(s) 112. In accordance with some embodiments, the version label 115 is designed in order to reflect this, as the variant component must be null.

According to one embodiment, version labels 115 are built by the label determination component 114 in conjunction with the version determination component 110 in such a way that they can be totally ordered for a given resource 134, i.e. it is always possible to assess if one version is anterior to another one. This importance will be appreciated by those skilled in the art as this property enables a resource user 138 to always find the antecedent of a given version based on the structure of the label 115.

Accordingly, first an order [symbol] on version labels 115 through is defined:

∀M,M′,m,m′,μ,μ′,v,v′,s,s′ non negative integers

M<M′ [symbol] [M.m.μ:v]/s [symbol] [M′.m′.μ′:v′]/s′

m<m′ [symbol] [M.m.μ:v]/s [symbol] [M.m′.μ′:v′]/s′

μ<μ′ [symbol] [M.m.μ:v]/s [symbol] [M.m′.μ′:v′]/s′

v<v′ [symbol] [M.m.μ:v]/s [symbol] [M.m.μ:v′]/s′

s<s′ [symbol] [M.m.μ:v]/s [symbol] [M.m.μ:v]/s′

Version labels 115 evolve in such a way that the following property always holds: Proposition 1. Monotonicity of stamps

∀M′,m′,μ′,v′,s′ non negative integers

[M.m.μ:v]/z [symbol] [M′.m′.μ′:v′]/s′ [symbol] s<s′

Intuitively, this property says that for a given resource r 134, the stamp stamp (r)=s tracks all change history regardless of the evolution of the version label 115 (which is ruled by the preservation of significant semantic properties, as detailed infra). In order to abstractly handle resources 134, three so called destructors are defined to access those attributes:

Identifier(r)=l

content(r)=c

version(r)=[M.m.μ:v]/s

Similarly, versioning labels 115 may be deconstructed according to the following functions:

major([M.m.μ:v]/s)=M

minor([M.m.μ:v]/s)=m

micro([M.m.μ:v]/s)=μ

update([M.m.μ:v]/s)=v

stamp([M.m.μ:v]/s)=s

Given the above, a partial order over versioned resources 134 may be built as follows.

Definition 1. Partial Ordering of Resources

∀r,r′ r [symbol] r′ iff identifier(r)=identifier(r′) [symbol] version(r) [symbol] version(r′)

The following designation mechanism is implemented in one embodiment to select and retrieve resources 134. Resources 134 may be designated through a term built from the following syntax:

D::=l|l[V₁]|l/s|l/*|l/?

V₁::=*|?|M|M.V₂

V₂::=*|?|m|m.V₃

V₃::=*|?|μ

Informally, the “?” denotes all available components that match some versioning constraints, whereas “*” denotes the highest available component, and therefore, is always a singleton (or the empty set if the condition is not satisfied). The notation l[?] designates the set containing all versions of the resource l, l [*] the last qualified version, l [3.*] designates the last minor and micro version derived from the major revision 3 of l. It will be appreciated that for some value M,m,μ the designation l[M.m.μ] always maps to a singleton (provided this derivation belongs to the history of the resource 134), as well as l/s, under the same condition. The notation l/? designates the set of all variants of l regardless any versioning information, and l/* the most recent element of this set, if any.

All resources 134 of the versioning service ε provided by VMS 102 may be retrieved through a resolution function that takes as an input the designation term, and returns a set of resources 134 according to the history. The resolution function, noted “!” is defined by the following table:

Definition 2. Resolution of References

| reference | result | comment | qualified |
|---|---|---|---|
| !(l) | !(l/*) | shorthand | |
| !(l/?) | {r ∈ ε \| identifier(r) = l} | all variants | yes/no |
| !(l/*) | sup [symbol] [!(l/?)] | last variant | yes/no |
| !(l/s) | {r ∈!(l/?) \| stamp(r) = s} | a particular variant | yes/no |
| !(l[M]) | !(l[M.*]) | shorthand | |
| !(l[*]) | sup [symbol] [!(l[?])] | last version | yes |
| !(l[?]) | {r ∈!(l/?) \| major(version(r)) > 0} | all variants | yes |
| !(l[M.m]) | !(l[M.m.*]) | shorthand | |
| !(l[M.*]) | sup [symbol] [!(l[M.?])] | last M version | yes |
| !(l[M.?]) | {r ∈!(l/?) \| major(version(r)) = M} | all M versions | yes |
| !(l[M.m.μ]) | {r ∈!(l[M.m.?]) \| micro(version(r)) = μ} | this version | yes |
| !(l[M.m.*]) | sup [symbol] [!(l[M.m.?])] | last M.m version | yes |
| !(l[M.m.?]) | {r ∈!(l[M.?]) \| minor(version(r)) = m} | all M.m versions | yes |

Returning to FIG. 1, the instructions 106 stored in memory 108 of the VMS 102 also include a certification module 110 that outputs a certification 112 for a resource 134 in accordance with a verification of the resource 134 with respect to its corresponding specification 112 (internal or external). In some embodiments disclosed herein, three different parameters related to a resource 134 that can be changed, according to the model of resources described supra. The resource r 134, its internal specification Iᵣ, and its external specification Eᵣ,c (collectively the specification 112). The triple [symbol] r,Iᵣ,E_{r,c} [symbol] may evolve in many different ways, but to be certified by the VMS 102, the fundamental property described below with respect to version consistency must always be verified.

It will be appreciated that unqualified resources have a versioning label 115 and therefore can be designated, retrieved and delivered on demand by the VMS 102 to a resource user 138. It will further be appreciated that by construction, a version label 115 having a non zero variant is unqualified. As an example of evolution dynamics, presented herein is a diagram capturing two evolution steps of a resource r 134, and then an evolution step of its internal specification Iᵣ (e.g. to take in account added features)

### Example 1

Operations for a resource r 134 with identifier l and specification Iᵣ are shown below. It will be appreciated that the following operations may be exclusively undertaken by the resource owner 136 (or other entity having permission to play this role).

The preceding diagram presents an instance wherein three update operations are applied on a certified resource 134 (with version label 115 l[1.1.3:0]/13). The first two update operations are intended to track modifications of the content of the resource 134, whereas the third update operation is intended to track the modification of the internal specification. The last step corresponds to a minor qualification, which is to establish that the fundamental invariant is satisfied: the resource satisfies the modified specification and this one is a logical extension of the original specification (and therefore, is backward compatible). From this last property, the modified specification 112 may be deduced to also be a logical extension of the fundamental invariant, since the original specification 112 was so.

As used herein, the VMS 102, via processor 104 or other suitable component associated therewith, may utilize logic in the form of software, hardware, or a combination thereof. The expressiveness of the logic may depend on the requirements of the application, however, higher order logic may be used, implemented with powerful proof assistants, embedding interactive/automated tactic based theorem provers and is generic enough to cover practical cases.

In one embodiment of the subject disclosure, the logic implemented by the VMS 102, i.e., logic [symbol] , should be equipped with a particular relation that checks well-formedness of terms, in order to be sure that a logical specification 112 is indeed a term that can be managed by axioms and theorems. It should be appreciated that this relation wf(P), or an equivalent, may be implemented as a generic typing relation, as type(P, prop). The logic [symbol] may also be equipped with a proof system able to explicitly handle proof terms, e.g., [symbol] ├ proof(p,P) as the logical relation establishing that p is a proof of P in [symbol] . Consequently, proving a property P is a process that will construct a proof term p. It will also be appreciated that it may be more difficult to build the proof term than to check for its correctness, the latter capable of being implemented through very simple and efficient algorithms. See, e.g., the manner in which proof terms are handled through lambda term in the COC higher order type theory of T. Cocquand and G. Huet. “The Calculus of Constructions.” INRIA Research Report RR-0530, May 1986, the entire disclosure of which is incorporated by reference herein. See also, the manner in which proofs become first order entities as set forth in F. Kirchner and C. Muñoz. “The Proof Monad.” The Journal of Logic and Algebraic Programming 79.3 (2010): 264-277, the entire disclosure of which is incorporated by reference herein.

Furthermore, such implementation may be accomplished via OpenTheory as discussed in J. Hurd. The OpenTheory Standard Theory Library. In NASA Formal Methods, 17791. Springer, 2011, the entire disclosure of which is incorporated by reference herein, and via Dedukti which proposes a universal and pivotal proof handling mechanism. See, e.g., M. Boespflug, Q. Carbonneaux and O. Hermant, “The lambda-Pi-calculus Modulo as a Universal Proof Language.” In PxTP 2012, and R. Saillard. “Dedukti: a universal proof checker.” In: Foundation of Mathematics for Computer-Aided Formalization Workshop. 2013, the entire disclosures of which are incorporated by reference herein. More generally, see e.g., the manner in which proof terms are built and computed in any logic based on the Curry-Howard correspondence, as discussed in N. G. De Bruijn. “On the roles of types in mathematics.” The Curry-Howard isomorphism, 1995, vol. 8, pp. 27-54, the entire disclosure of which is incorporated by reference herein.

Additionally, extensions suited to domain specific applications may be expressed as additional theories [symbol] [symbol] , [symbol] [symbol] , . . . that work on top of [symbol] . In those cases, the [symbol] [symbol] [symbol] , [symbol] [symbol] , . . . ├ proof(p,P) may be the natural extension of the notation presented above, to express a proof in the aforementioned set of theories.

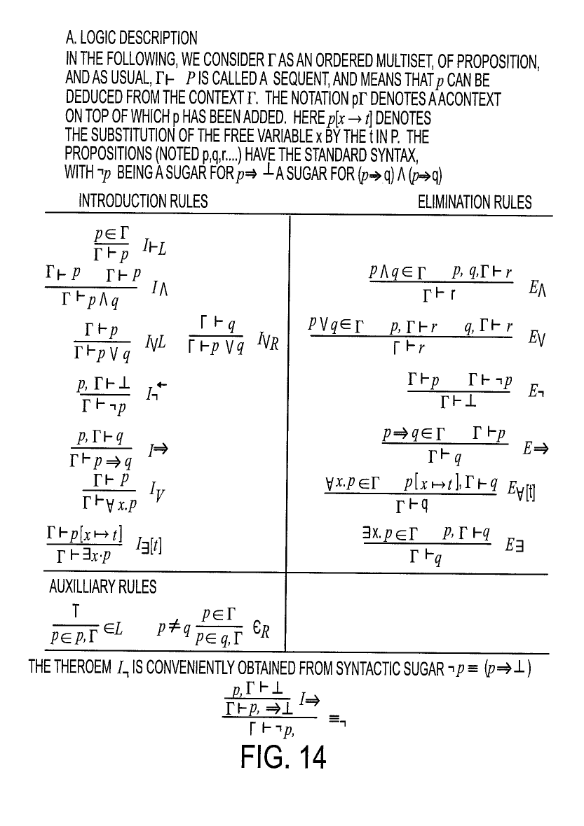

An example illustration of the foregoing may be considered via the higher order intuitionistic logic [symbol] shown in FIG. 14 (wherein the associated proof system is based on natural deduction, and wherein elimination and introduction rules are associated with each construct). Consider the formula:

∀A.∀B.((A [symbol] B) [symbol] B)

An example proof using sequents and natural deduction is:

This proof can be mapped into a structurally equivalent proof term using all applied rule names:

I_{∀}(I_{∀}(I [symbol] ( [symbol] (ε_{L},I_{├}(ε_{R}(ε_{L})))))))

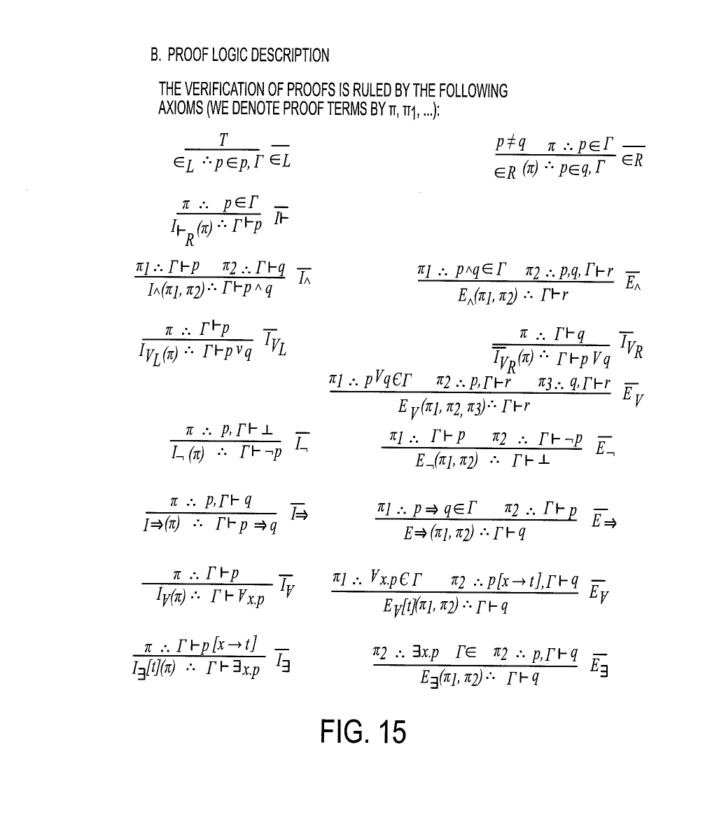

which can be checked for correctness using a dedicated predicate proof(p,P) (abbreviated p∴P in infix form) defined logically by the proof system shown in FIG. 15:

When a resource owner 136 asks the VMS 102 for a certification operation for a resource r 134 (creation of a new major, minor or micro version), the resource owner 136 provides one or more proofs, depending on the past operations and the current context. Those proofs are checked for correctness, i.e, the VMS 102 verifies that they indeed establish the expected properties Pᵢ. This means that the VMS 102 via the certification module 116 or other suitable component associated therewith, verifies the property [symbol] , [symbol] [symbol] [symbol] , [symbol] [symbol] [symbol] , . . . ├ proof(p,Pᵢ). Moreover, depending on the kind of change, the VMS 102 verifies some “structural” properties: well-formedness of specifications 112 when they changed, and that the resource 134 satisfies the specification 112.

It will be appreciated that while checking a proof is an easy operation, building the proof term (formally proving a property) can be of unbounded difficulty, depending on the application domain (and consequently on the power of theories operated by the resource owners 136). However, embodiments contemplated herein capture many useful scenarios via simple theories, and proofs can be established either by a proof assistant (used remotely by the resource owner 136, or operated as an additional service of VMS 102) or even by specialized programs, such as type checkers, or specialized algorithms. It will be appreciated that run-time execution performance of such programs would not be as crucial as during development cycles, since they are involved only during the certification phase. Properties such as schema membership (XML validation, database relational schema) may be processed automatically by dedicated algorithms, provided such schemes are translated into [symbol] : inside an appropriate theory. Similarly, API signatures for a software library, making use of decidable type systems, may be similarly processed through an equivalent approach.

The following provides change cases with respect to the versioning certification. The changes involve three entities: the resource r 134, its internal specification Iᵣ, and its external specification E_{r,c} for a particular client (or client family) c.

When a resource r 134 satisfies a logical formula F, this is noted as r [symbol] F. The C relation expresses strict logical implication, i.e

F₁⊂F₂ iff F₂ [symbol] F₁ [symbol] [symbol] (F₁ [symbol] F₂)

Whereas ⊂ just expresses the logical implication (therefore, is reflexive):

F₁⊂F₂ iff F₂ [symbol] F₁

The [symbol] F relation expresses “partial disjunction”, i.e, that a logical intersection F exists between two formulas:

F₁∩_{F}F₂ iff F⊂F₁ [symbol] F⊂F₂ [symbol] [symbol] (F₁⊂F₂)

[symbol]

Defined this way, this relation produces two subcases: one where F₂⊂F₁ (F₂ is strictly more specific than F₁) and one where [symbol] (F₂⊂F₁) (F₁ and F₂,are strictly conjunctive). Both situations make sense when interpreting major version evolution (which potentially can raise incompatibility issues). The first one expresses cases where a specification 112 is restricted (producing some regression in the expectation), the other one expresses situations where a specification 112 evolves by extending some points, but regressing on others.

The ≈ relation just expresses logical equivalence (but is typically used when F₁ and F₂ are syntactically distinct):

(F₁≈F₂) iff F₂ [symbol] F₁

It is easy to show that the ⊂,⊂, ≈ relations are transitive, and moreover, since the logic is expected to be sound, it may be assumed that the following property holds:

(F₁⊂F₂ [symbol] r [symbol] F₂) [symbol] r [symbol] F₁

It should be noted that the change of the resource r 134 into r′ by a particular δ relation, such that δ(r)=r′.

The certification process set forth in the subject disclosure aims at controlling the evolution of the tuple [symbol] r, [symbol] ᵣ,Iᵣ,E_{r,c} [symbol] for all resource r 134, for all clients c of r and associated specifications Iᵣ and E_{r,c} 112 in such a way that the resource 134 always satisfies all specifications 112, and in such a way that the external specification visible by the client/resource user 138 is a specialization of the internal specification (controlled by the resource owner 136). Moreover, both external and internal specifications 112 must always specialize the initial invariant 111 that was definitely associated with the resource 134, noted [symbol] ᵣ. This fundamental scheme is expressed by the following diagram:

The changes potentially affecting any of the three dynamic parameters may be examined (therefore, excluding the base invariant/111), focusing on the consequences both from the resource user's 138 (client's) and resource owner 136 perspectives, in terms of how their respective version labels will evolve. The elements with color red correspond to the logical relations that must be established, whereas the green ones express what can be deduced both from the previously established relations and from the proved statements (and therefore, do not need explicit formal treatment by the service).

As many combinations exist, the cases may be divided into two parts: the first one regarding with constant resources 134 (no change regarding the resource 134 itself, but only with respect to the associated specifications 112), whereas the second part considers all cases where the resource 134 varies.

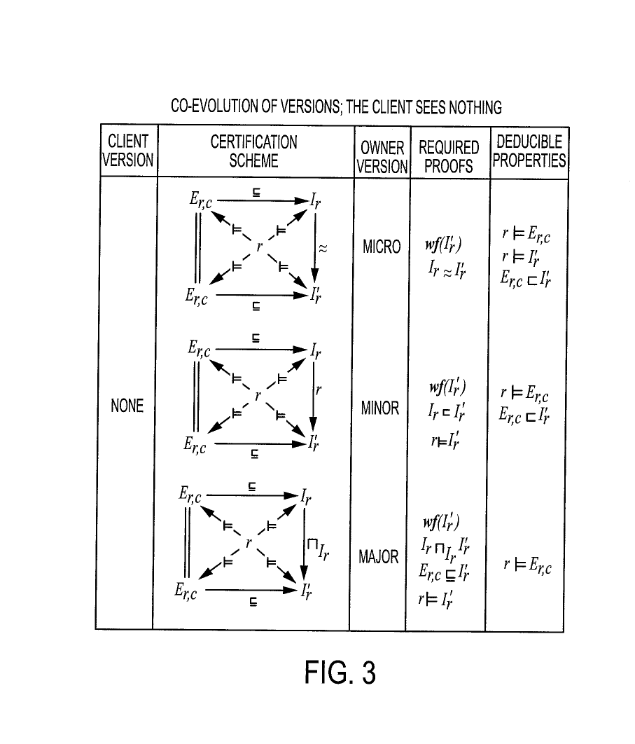

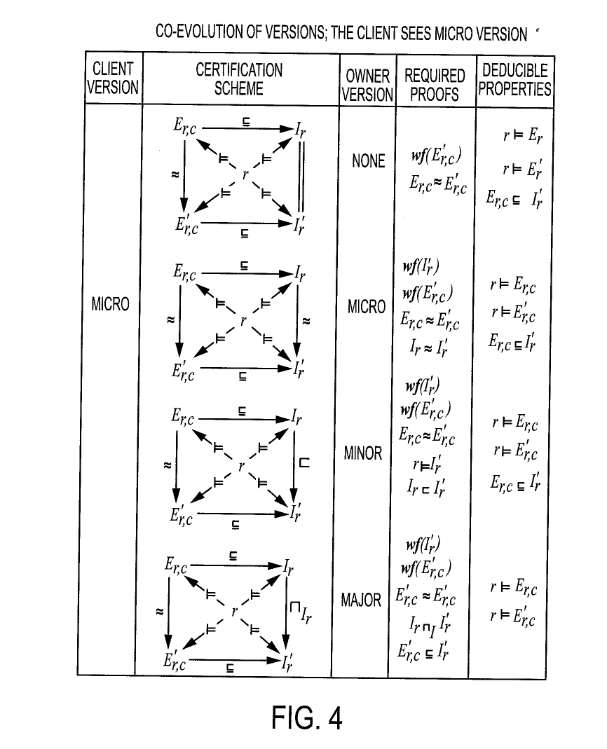

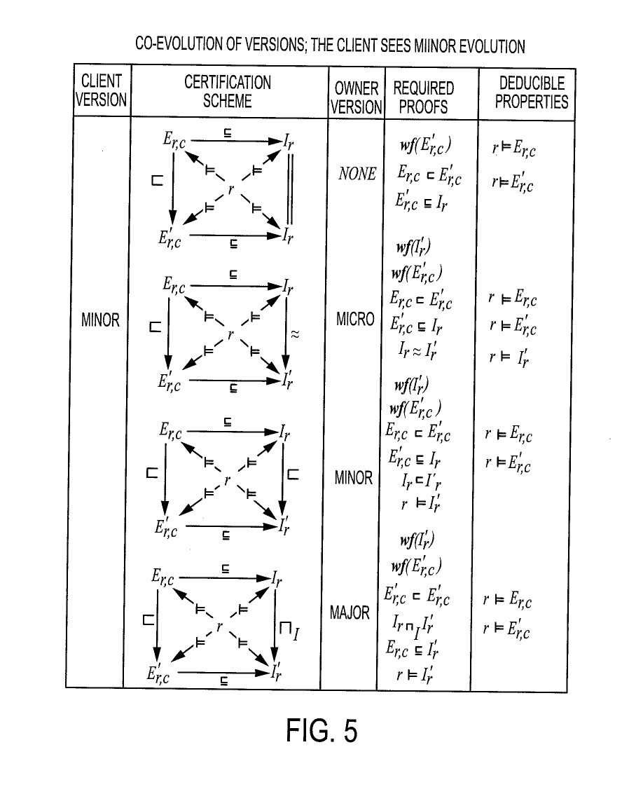

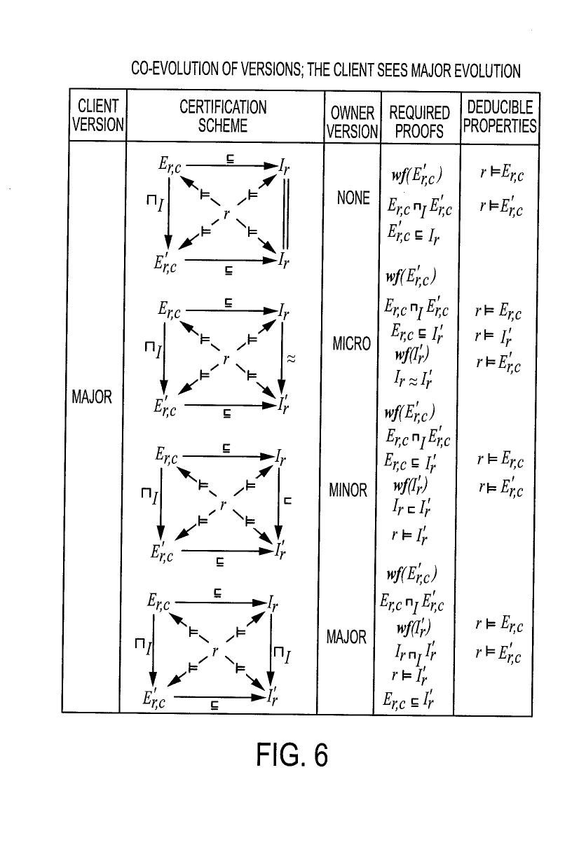

FIG. 3 shows all certification schemes related to the cases where the resource user 138 (i.e., the client) will not perceive any impact on his version label 115, because only the internal specification changed, and more precisely, changed in a way that doesn't affect the external specification associated with it. FIG. 4 considers changes perceived by the resource user 138 as having micro effects, and FIGS. 5 and 6 as having respectively minor and major effects.

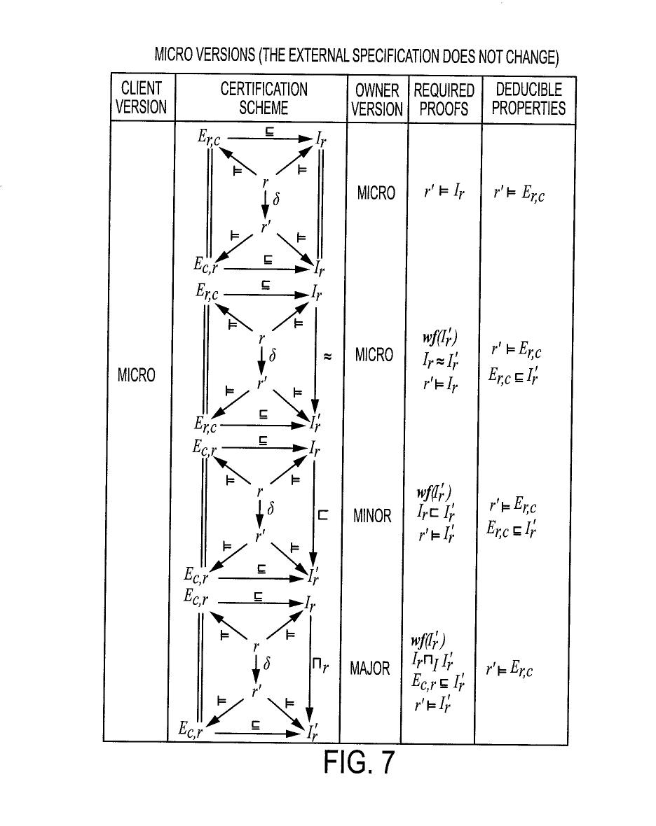

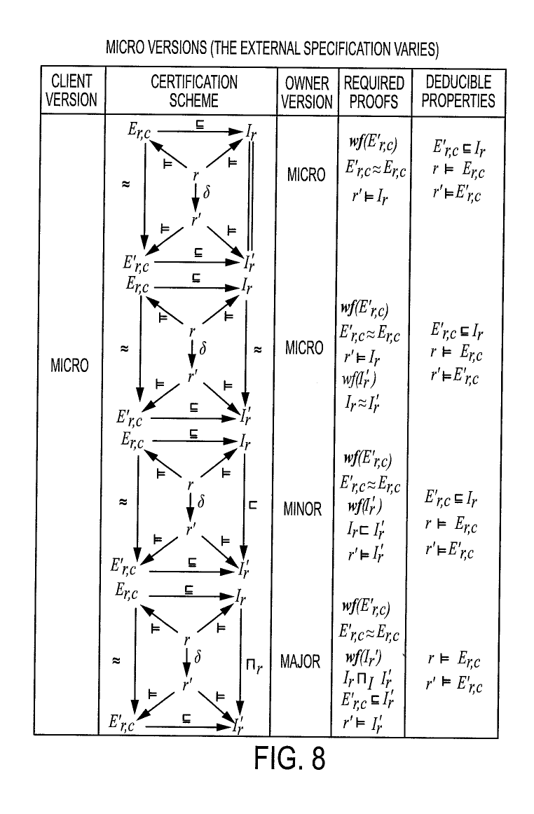

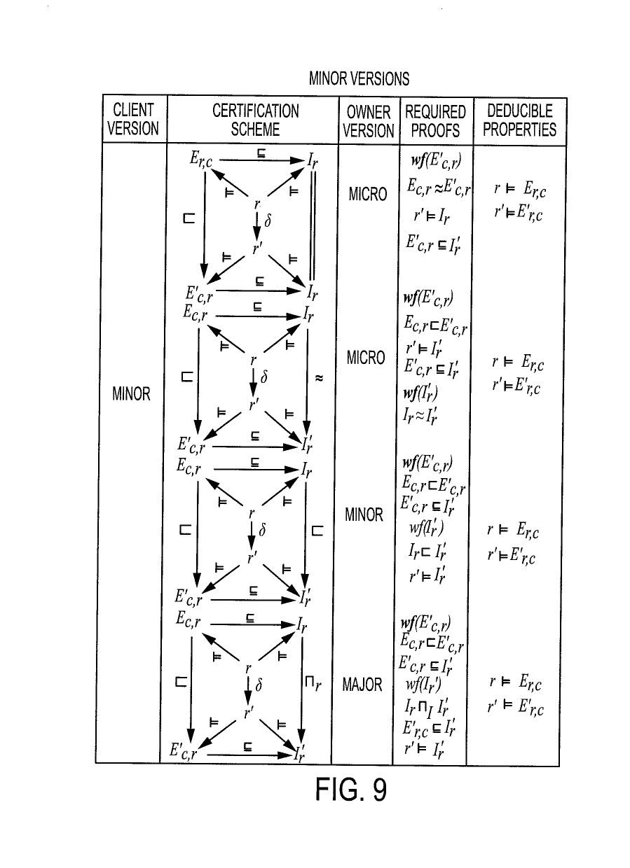

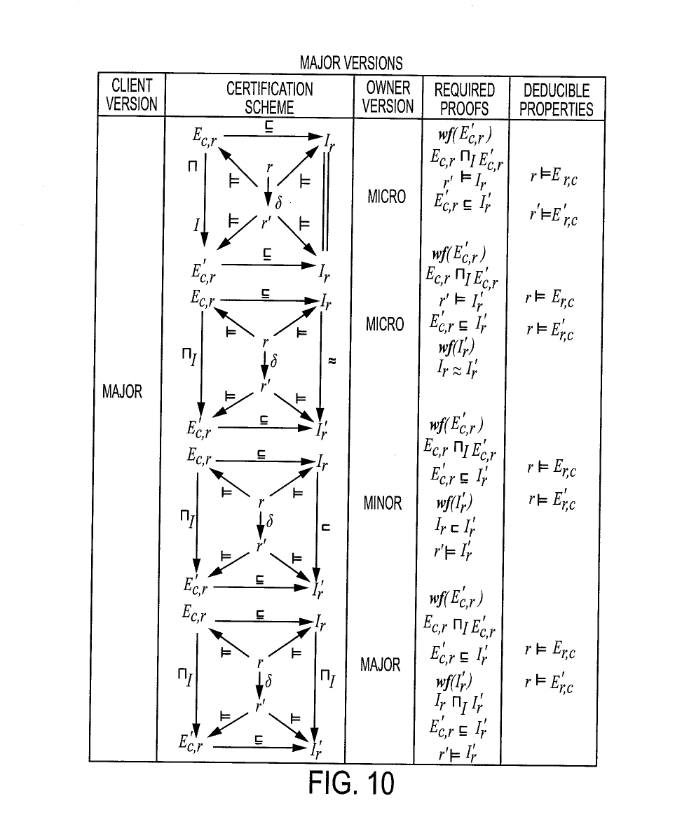

Three cases may be distinguished in accordance with the embodiments disclosed herein, from the point of view of a resource user 138 (i.e. client c), working with an external specification E_{r,c} over a resource r 134. FIG. 7 provides an illustration of micro changes with a static external specification, and FIG. 8 addresses micro changes for the other case. FIGS. 9 and 10 respectively consider micro and major impacts.

Returning to FIG. 1, the memory 108 of the VMS 102 may represent any type of non-transitory computer readable medium such as random access memory (RAM), read only memory (ROM), magnetic disk or tape, optical disk, flash memory, or holographic memory. In one embodiment, the memory 108 comprises a combination of random access memory and read only memory. In some embodiments, the processor 104 and memory 108 may be combined in a single chip. The network interface(s) 120, 122 allow the computer to communicate with other devices via a computer network, and may comprise a modulator/demodulator (MODEM). Memory 108 may store data the processed in the method as well as the instructions for performing the exemplary method.

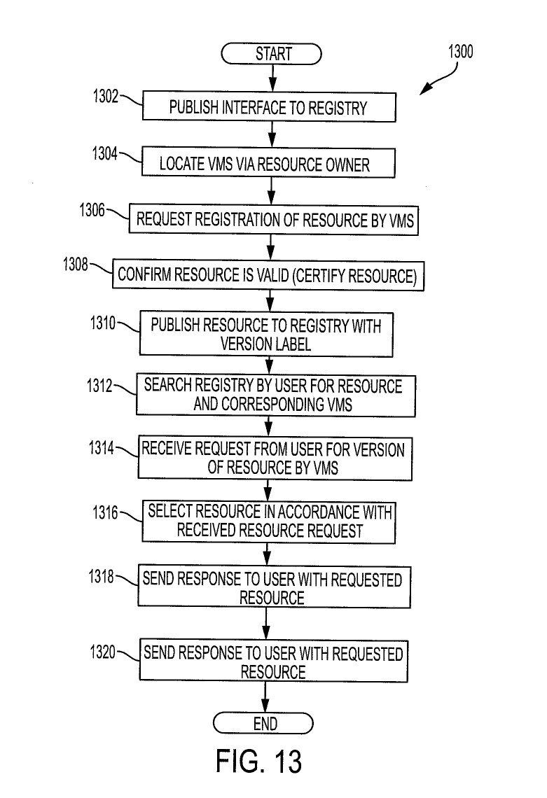

The digital processor 104 can be variously embodied, such as by a single core processor, a dual core processor (or more generally by a multiple core processor), a digital processor and cooperating math coprocessor, a digital controller, or the like. The digital processor 104, in addition to controlling the operation of the VMS 102, executes instructions 106 stored in memory 108 for performing the method outlined in FIG. 13.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The VMS 102 also includes one or more input/output (I/O) interface devices 120 and 122 for communicating with external devices. The I/O interface 120 may communicate with one or more of a display device 124, for displaying information, and a user input device 126, such as a keyboard or touch or writable screen, for inputting text, and/or a cursor control device, such as mouse, trackball, or the like, for communicating user input information and command selections to the processor 104. The various components of the VMS 102 may all be connected by a data/control bus 128. The processor 104 of the VMS 102 is in communication with an associated network 101 via a link 142. A suitable communications link 142 may include, for example, the public switched telephone network, a proprietary communications network, infrared, optical, or other suitable wired or wireless data transmission communications.

The system 100 further includes a registry 130, such as a UDDI registry, in communication with the computer network 101 via a communications link 132. The link 132 between the computer network 101 and the registry 130 may be accomplished via any suitable channel of data communications such as wireless communications, for example Bluetooth, WiMax, 802.11a, 802.11b, 802.11g, 802.11(x), a proprietary communications network, infrared, optical, the public switched telephone network, or any suitable wireless data transmission system, or wired communications. The registry 130 is capable of implementation on components of the VMS 102, e.g., stored in local memory 108, i.e., on hard drives, virtual drives, or the like, or on remote memory accessible to the VMS 102., as a standalone UDDI registry accessible to the VMS 102, the resource owner 136, the resource user 138 via the computer network 101, e.g., the Internet. The registry 130 may store specifications 112, labels 115, certifications 118, resources 134, information about resource owners 136, information about resource users 138, information about the VMS 102, and the like.

Also depicted in FIG. 1 are a resource owner 136 and a resource user 138. It will be appreciated that the representative items 136 and 138 correspond to devices, users, entities, or the like, depending upon the particular resource 134 being versioned. In accordance with one embodiment disclosed herein, the resource owner 136 publishes one or several logical descriptions, at various levels of precision, which characterize the resource 134 and serve as a formal agreement about the intended usage of the resource 134. Resource users 138 may subscribe to one “contract” and get access to the resource 134 through a dedicated version scheme management. Each time the resource owner 136 certifies a new version, the VMS 102 ensures that this will be propagated to the “contracts”, i.e that each version label 115 associated with the contracted interface will be derived in a semantically consistent way.

The resource owner 136 creates the resource 134 and decides how the resource 134 evolves. This includes deciding when and how to publish the resource 134 and also what type of access and use should be allowed for different users 138. The resource owner 136 also defines the domain specific theories needed (or use/extend those that might be proposed by the VMS 102), and designs the properties needed to characterize the resource 134. The resource extension (its digital content as a bitstream) may be directly uploaded into the memory 108 of the VMS 102 (in the registry 130), or just localized (local memory of the resource owner 136) through a pointer that allows the VMS 102 to access the content, i.e., resource 134, when needed. The actions that the VMS 102 allows/expects from the resource owner 136 are detailed below.

Accordingly, in one embodiment, the VMS 102 allows theory creation by the resource owner 136. Theory creation corresponds to the uploading, by the resource owner 136 to the VMS 102, of a source file compatible with the underlying logic operated by the VMS 102, and an associated name that must not be already used by the VMS 102 for this particular owner 136. This means that the VMS 102 has a dedicated parser and computational means to verify/type the provided definitions (i.e., to check for well-formedness). Once loaded and verified by the VMS 102, the definitions can be used in other operations.

The VMS 102 also enables the creation of resources 134 by the resource owner 136. Resource creation, in embodiments contemplated herein, allows resource owner 136 to specify a name uniquely associated with the target resource 134. Accordingly, the selected name may be used to designate the revisions thanks to the version labels 115, as in cobra.socket.api, which could be subsequently referenced as in e.g. cobra.socket.api[1.2.0].

Generation of the specification 112 by the resource owner 136 includes creation of the internal and external specifications. For the internal specification, the VMS 102 receives the resource name to which the specification 112 will be attached, and a logical formula, which will be checked for well-formedness. The VMS 102 returns a unique identifier to the resource owner 136, so that the specification 112 can be designated without ambiguity for future operations.

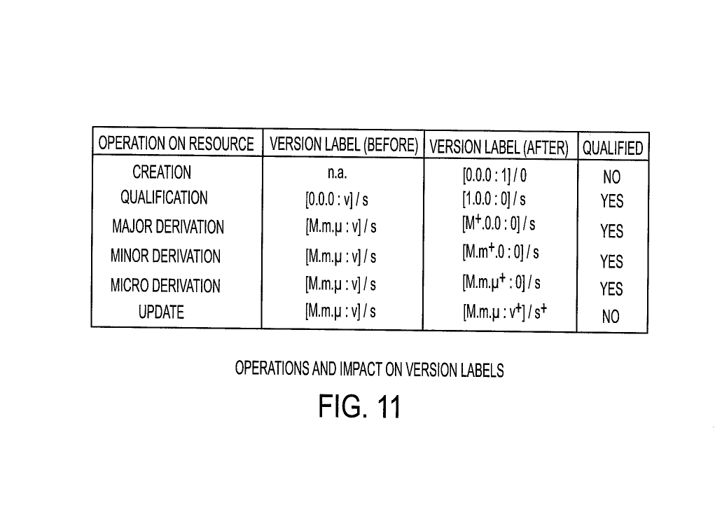

The resource owner 136 may also update a resource 134, via the uploading of a novel extension for the resource 134, or equivalently, application of a patch or a new internal version label is computed accordingly. An example of such updating is shown in FIG. 11. The resource owner 136 may further update the specification 112 via uploading of a novel extension for the resource 134 (or equivalently, application of a patch); a new internal version label is computed accordingly, as illustrated in FIG. 11. The resource owner 136 is also involved in the certification/qualification of the resource 134 by the VMS 102. Accordingly, this corresponds to the first stage involving a logical characterization. Once certified/qualified, the resource 134 may be derived and made visible to external users 138. As parameters, the VMS 102 receives the resource label l, a reference to the invariant property Iₗ and to the internal property Iₗ, and the proofs: the invariant 111 is implied by the internal specification in the defined context [symbol] [symbol] ᵢ├ [symbol] ₗ⊂Iₗ; and the resource 134 satisfies the internal specification in the defined context [symbol] , [symbol] ├l [symbol] Iₗ.

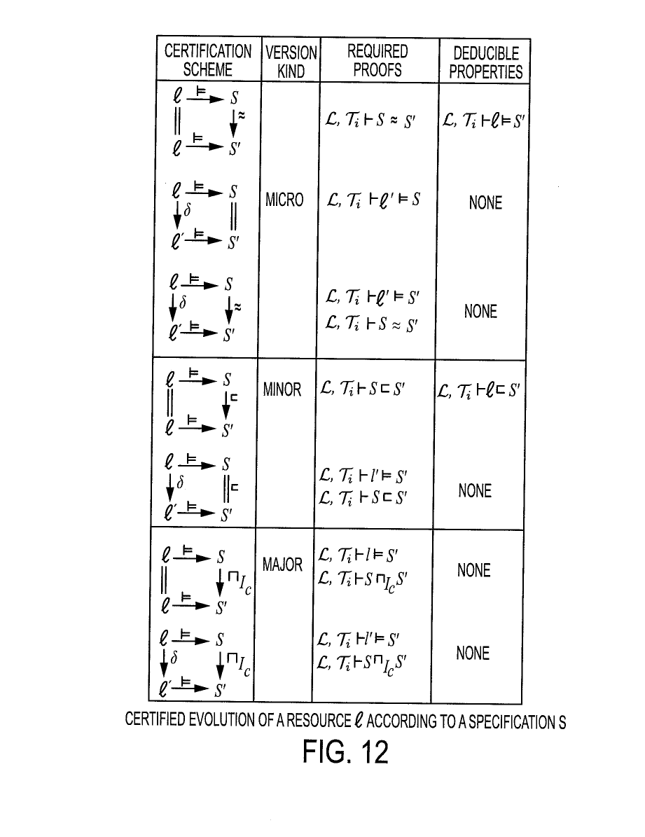

The VMS 102 then verifies the proofs and if correct, qualifies the resource 134, generating the first certified version label 115, as depicted in FIG. 11. The VMS 102, in association with the resource owner 136, may also facilitate derivation, so as to compute a new version for a particular resource 134, whose name is given as a parameter, as well as the type of version: micro, minor, or major. Depending on the version type, different proofs may be required by the VMS 102, so as to minimize the proving cost. See, e.g., FIG. 12. The publication of the resource 134 by the VMS 102 requires the resource name as parameter and synchronize the last qualified version to generate the external version labels for all users. Proofs will be asked by the VMS 102 according to the global co-evolution schemes. In FIGS. 11 and 12, as referenced above, x⁺ is used to denote x+1. FIG. 11 defines the transformations of the version label 115 according to the operation done on a resource r, where version(r)=[M.m.μ:v]/s, shown in the certified evolution of a resource l 134 according to a specification S 112.

With respect to the resource user 138, the embodiments disclosed herein, the resource user 138 may access the set of bitstream extension (the resource content) corresponding to particular versions, as discussed above with respect to the designation mechanism described supra, but restricted to the certified/qualified version only. The resource user 138 may further have access to the corresponding external specification 112. For downloading of the resource 134, the VMS 102 expects a full version label 115 (e.g. dp.api[2.1.3]), and returns a set of resource content, associated with its exact version label 115. Such a label 115 will resolve into this particular content if a subsequent access is required. As an example, a first request with db.api[1.2.?] may return {(c₁,db.api[1.2.1]),(c₂,db.api[1.2.2])} (where cᵢ denotes the respective bitstream contents) whereas a db.api[1.2] request will be interpreted by the VMS 102 as db,t[1.2.*] and would return the last content available for this major and minor version in the given context, i.e. the singleton {<c₁,db.api[1.2.2])}. The resource user 138 may download the specification 112 using the same communication scheme to access each external specification 112 associated with each version resolved by the VMS 102.

For example, when the resource 134 is a technical document (e.g. a product nomenclature or a maintenance manual), the resource owner 136 may be the product supplier, the resource user 138 may be a customer or an outsourcing partner, and the VMS 102 may be a service specialized in maintaining up-to-date and consistent documentation for highly demanding businesses (e.g. Aeronautics, medical instruments . . . ). As another example, when the resource 134 is a smartphone application, the resource owner 136 may be an application provider wanting to control the quality of its application on any OS type and versions (or depending on countries and languages), the resource user 138 may be an individual, and the VMS 102 may be the end-user front-end to download the right application according to the end-user smartphone type and configuration. Other examples of a resource 134 may include, for example and without limitation, a computer program, a firmware program, a technical document, a technical document, a smartphone application, a computer program, a firmware program, a piece of hardware, or other item that is produced/released in an initial version with updates or subsequent versions released.

Turning now to FIG. 13, there is a flowchart 1300 illustrating a versioning management method in accordance with one embodiment of the subject disclosure. It will be appreciated that the version management system 102 includes a common gateway/address for provider/user applications to access a wide variety of services. The method 1300 begins at 1302, whereupon the VMS 102 publishes its interface to the UDDI registry 130 that can be used by other services to locate the VMS 102. At 1304, a Resource Owner O 136 that wants to set up a certification process for a resource r 134 contacts the UDDI registry 130, in order to locate the VMS 102. Once the resource owner O 136 has located the VMS 102, the resource owner O 136 performs a binding and asks to register the resource r 134 at 1306. In one embodiment, the resource owner O 136 also sends the specification 112, i.e., the contract definition, related to the resource r 134 to the VMS 102. At 1308, the VMS 102 confirms that the resource r 134 is valid (i.e., well-formed as discussed in greater detail below and responds with a confirmation to the resource owner O 136, that the resource r 134 has been certified.

The VMS 102 the publishes the resource r 134 with a certified/qualified version label (i.e. a label 115 that represents the current state of the resource r 134) at 1310 by sending the information to the UDDI registry 130. At 1312, a Resource User U 138 contacts the UDDI registry 130 to locate a resource r 134 available via the VMS 102. It will be appreciated that in one embodiment, the resource owner O 136 locates VMS 102 via the UDDI registry 130, and interacts with the VMS 102 to qualify and upload the resource r 134 to the UDDI registry 130 hosted by the VMS 102. In such an embodiment, the VMS 102 publishes this certified resource r 134 on the UDDI registry 130 for later availability to the Resource User U 138 as illustrated in FIGS. 2 and 13. In accordance with the output of the UDDI registry 130, the resource user U 138 selects the VMS 102. Once the VMS 102 is located at 1312, operations proceed to 1314, whereupon the resource user U 138 contacts the VMS 102 and requests a specific version or range of versions of the resource r 134.

At 1316, the VMS 102 selects the resource r 134 based on the information received from the resource user U 138 related to the version label but also to the specification 112 (i.e., the contract) that the resource user U 138 has received. In accordance with one embodiment, the resource user U 138 communicates the specification 112 (i.e., the contract) to the VMS 102. The VMS 102 then sends a response (e.g., that the specific version of the resource r 134 that is available to the resource user U 138) at 1318. After receiving the response, the resource user U 138 performs a binding with the VMS 102 or resource owner O 136 at 1320. It will be appreciated that as illustrated in FIG. 13, the VMS 102 functions as an intermediate service between the Resource Owner O 136 and the Resource User U 138.

### Example

A provider (resource owner 136) manages a library offering persistent storage operations, i.e., the resource 134. This resource 134 is named STO and is made available as a compiled module. The resource owner 136 chose to expose two different views of this library (resources 134): a basic one including creating/opening a persistent store, storing, deleting and retrieving data and a more complex one additionally handling transactions. The owner 136 of the STO resource 134 uses an object-oriented dedicated theory to describe the resource 134, focusing on classes and methods naming and typing. The fundamental invariant 111 of the STO resource 134 has been defined such as dealing with a class, three methods to deal with data, and three basic functions to create, open and delete a database.

[symbol]

≡class(STOHandler)
[symbol] language(Python2)
[symbol] method(STOHandler, store)
[symbol] method(STOHandler, retrieve)
[symbol] method(STOHandler, close)
[symbol] function(create)
[symbol] function(open)
[symbol] function(delete)

Note that according to the vision of the resource owner 136, signatures of methods/functions are not considered as fundamental, and therefore, could change along the lifetime of the resource 134, however, the programming language and version must stay stable. In the instant example, the external specification 112 describes a minimal view on the functionality offered by the API, namely, the signatures of methods and functions, including the potential exceptions they may raise.

E_{STO}≡ [symbol] _{STO}
[symbol] signature(STOHandler.store, [string, string], void)
[symbol] signature(STOHandler.retrieve, [string], [string])
[symbol] signature(STOHandler.close, [ ], void)
[symbol] signature(create, [string], STOHandler)
[symbol] signature(delete, [string], void)
[symbol] signature(open, [string], STOHandler)
[symbol] throw(create, Exception)
[symbol] throw(delete, Exception)
[symbol] throw(open, Exception)

With respect to the internal specification 112, it is usually more complex, as expected to help the resource owner 136 (e.g., the designer) maintaining the source code in a coherent way while hiding (potentially irrelevant) complexity to users. To illustrate this, consider three additional methods: check (verify the presence of a data in the store), replace (change a value using a known key) and put (store one or many values using the same key). The aforementioned methods may be used internally to build higher level operations such as the store method which perform storage with replacement, as in standard dictionary data structures based on hashing algorithm.

I_{STO}≡ [symbol] _{STO}
[symbol] signature(STOHandler.store, [string, string],void)
[symbol] signature(STOHandler.retrieve, [string], [string])
[symbol] signature(STOHandler.close, [ ], void)
[symbol] signature(create, [string], STOHandler)
[symbol] signature(delete, [string], void)
[symbol] signature(open, [string], STOHandler)
[symbol] method(STOHandler, check)
[symbol] method(STOHandler, replace)
[symbol] method(STOHandler, put)
[symbol] signature(STOHandler.check, [string], integer)
[symbol] signature(STOHandler.replace, [string, string], void)
[symbol] signature(STOHandler.put, [string, string], void)
[symbol] class(PathException)
[symbol] subtype(PathException, Exception)
[symbol] throw(create, PathException)
[symbol] throw (delete, Exception)
[symbol] throw(open, PathException)

Note also that exception management is more detailed thanks to a class specialization.

The verification (certification) of the specification 112, in accordance with embodiments of the subject disclosure, relate to the well-formedness of logical specification is established by proofs using a generic theory for the basic logic, plus a language dedicated theory. As an indication of the application of the latter theory for the illustrative case presented above, it is noted that x:y is the infix notation of the predicate type(x, y), and label,integer, . . . are built-in predicates to assess lexical properties of items, as depicted in:

type(x,y), and label, integer,... are built-in predicates to assess lexical properties of items):

| | | | | |
|---|---|---|---|---|
| ∀P. | P:prop | [symbol] | ├ P | |
| ∀x,t. | t:type | [symbol] | (x:t):prop | |
| | | | void:type | |
| | | | any:type | |
| | | | type:type | |
| | | | prop:type | |
| | | | integer:type | |
| | | | string:type | |
| ∀t. | t:type | [symbol] | list(t):type | |
| ∀c. | class(c) | [symbol] | c:type | |
| | | | class(Exception) | |
| ∀x. | integer(x) | [symbol] | x:integer | |
| ∀x. | string(x) | [symbol] | x:string | |
| ∀t. | t:type | [symbol] | [ ]:list(t) | |
| ∀e,L,t. | t:type [symbol] e:t [symbol] L:list(t) | [symbol] | [e\|L]:list(t) | |
| ∀t₁,t₂. | subtype(t₁,t₂) | [symbol] | subtype(list(t₁),list(t₂)) | |
| ∀t. | t:type | [symbol] | subtype(t,any) | [symbol] any |
| ∀x,t₁,t₂. | subtype(t₁,t₂) [symbol] x:t₁ | [symbol] | x:t₂ | |
| ∀c₁,c₂,m. | subtype(c₁,c₂) [symbol] method(c₂,m) | [symbol] | method(c₁,m) | |
| ∀t₁,t₂,t₃. | subtype(t₁,t₂) [symbol] subtype(t₂,t₃) | [symbol] | subtype(t₁,t₃) | |
| ∀t. | | | subtype(t,t) | |
| ∀x. | label(x) | [symbol] | class(x):prop | |
| ∀x,y. | x:type [symbol] y:type | [symbol] | subtype(x,y):prop | |
| ∀x. | label(x) | [symbol] | function(x):prop | |
| ∀c,m. | class(c) [symbol] label(m) | [symbol] | method(c,m):prop | |
| ∀c,m,i,o. | method(c,m) [symbol] i:list(type) | [symbol] | o:type | |
| | | [symbol] | signature(c,m,i,o):prop | |
| ∀f,i,o. | function(f) [symbol] i:list(type) [symbol] o:type | [symbol] | signature(f,i,o):prop | |
| ∀c,m,e. | method(c,m) [symbol] e:Exception | [symbol] | throw(c.m,e):prop | |
| ∀f,e. | function(f) [symbol] e:Exception | [symbol] | throw(f,e):prop | |
| ∀f,c₁,c₂. | subtype(c₁,c₂) [symbol] throw(f,c₁) | [symbol] | throw(f,c₂) | [symbol] throw |
| ∀f,c₁,c₂. | (i₁ [symbol] i₂) [symbol] subtype(o₂,o₁) | [symbol] | signature(f,i₁,o₁) | |
| | | [symbol] | signature(f,i₂,o₂) | [symbol] sig |
| ∀t₁,t₂,T₁,T₂. | subtype(t₁,t₂) [symbol] subtype(T₁,T₂) | [symbol] | subtype([t₁\|T₁],[t₂\|T₂]) | |
| | | | subtype([ ],[ ]) | |

The formal proofs required by the VMS 102 for the three specifications will be [symbol] , ├ E_{STO} and ├ I_{STO} which can be reduced into ├ [symbol] _{STO}, ├ P₁ and ├ P₂ since I_{STO}≡ [symbol] _{STO} [symbol] P₂ and E_{STO}≡ [symbol] _{STO} [symbol] P₁ (Pᵢ being the additional properties, as discussed supra.

Continuing with the instant example, after submitting the internal and external specification 112, the resource owner 136 wants to produces a first certification of STO resource 134 (that is, the resource owner 136 asks the VMS 102 to generate a certified version label STO[1.0.0:0] 115). To that ends, the resource owner 136 provides the VMS 102 with a proof that the STO resource 134 satisfies the specification (STO [symbol] I_{STO}) 112. Here, the deepness of the proof is dependent upon the power of the underlying theory, on the properties of the programming language, and on the difficulty of the task (and also on the performance level of the algorithm/human operator).

In the weakest case, this compliance proof is reduced to an axiom (that is, the resource owner 136 engagement is credibility, possibly relying on static analysis tools that are not able to produce a VMS 102 compatible proof). Yet, proofs of well-formedness (├ P), as well as implication and partial disjunction of properties are required (and efficient) to control the quality of specifications and the consistency of the claimed evolution of versions. Also the absence of strong compliance proofs can be compensated by offering testing infrastructure at VMS level, and including runtime tests in the specifications, e.g. through dedicated predicates like test(context, code, value) or raises(context,code, exception), where code, value and exception are particular expressions of some suitable abstract language.

In the stronger case, the programming language is associated with a formal specification system (e.g based on predicate transformers) able to conduct semi-automatic proofs of correctness and to export proof terms in the VMS compliant form.

At intermediate levels, the programming language can be associated with static analysis tools (such as type checkers or property checker using partial evaluation or model checking).

To perform the first certification, the VMS 102 requires (sees) STO [symbol] I_{STO}, [symbol] ⊂E_{STO} (easy), [symbol] _{STO}⊂I_{STO} (easy, but longer), and E_{STO}⊂I_{STO} (a bit less easy). The only difficulty in the last one, is about proving properties like e.g. throw(create, PathException) [symbol] throw(create, Exception), which requires using appropriate subtyping oriented axioms: (proof scheme in abbreviated form)

With respect to the subject example, an illustration of co-evolution corresponds to a change that occurs in both the resource 134 (modification of source code and, accordingly, of the library resource STO) and in the internal specification 112. It will be appreciated that the store,retrieve,put and replace methods of the STOHandler class could accept any kind of value, and not only strings. This would constitute a major evolution from the internal side (the new specification is more specific, that is, δ(I_{STO})⊂I_{STO}, whereas the E_{STO} need not to be upgraded. As an example, the proof for the store method may be:

It will be understood that one of the main advantages of the approach provided herein is the flexibility it allows when treating different contracts between different users and owners. As is evident from the disclosure provided above, the resource owner 136, e.g., a provider, can expose a set of services, e.g., resources 134, and different resource users 138, e.g., consumers/clients, can access a subset of those. The inverse is also true, meaning that the set of resources 134, e.g., services, a resource user 138, e.g., a client/consumer, requires may be a union of resources 134 (and/or services) coming from different resource owners 136 (and/or service providers). The versioning management service, is capable of handling the evolution of the offered/requested resource/service 134 combinations. Furthermore, the advantages of formally certified versioning is be important for future resource users 138 of the VMS 102. In some embodiments disclosed herein, the systems and methods can allow different contracts according to the level of service that are offered for specifications 112 and proof design, e.g., a no proof based versioning certification would function similar to traditional software versioning systems; a proof-based versioning certification with proofs delivered by the resource owner 136 to the VMS 102; a proof-based versioning certification with proofs designed by the VMS 102; or a proof-based versioning certification with proofs and specifications developed by the VMS 102 based on trends observed by the totality of the resource users 138 and/or owners 136 of the VMS 102.

Furthermore, the systems and methods set forth in the subject disclosure may be adapted such that the VMS 102 could help other service providers in implementing relevant versioning policies. For example, cloud service brokerage, where cloud providers give their clients the right to choose services according to their specific needs, taking the responsibility of general conformance to relevant policies.

In addition to the foregoing, the subject disclosure contributes an essential step towards the systematic governance of digital resources, which requires that information technology assets (data, services, processes) be managed in a consistent and reliable way over time, with proper change management policies in place that can be enforced and verified. This is all the more challenging as information technology assets in a modern service world are distributed over networked infrastructures, owned by diverse stakeholders, internally or externally, within the same organizations or across organizations (service providers, data providers, customers, open data providers) and are subject to continuous change, often without proper notification to the dependent users critically impacted by remote, uncontrolled changes. Properly managing change is important to guarantee the quality and continuity of service that our customers expect and to ensure that the necessary evolutions of the provided services can be safely introduced without disruption. This is exceedingly gaining in importance in services in critical areas such as transportation or healthcare, where poor performance and service discontinuity may have very damaging effects, visible to public authorities and broad communities of users.

Accordingly, the a version management service (VMS) 102 provides consistent management of dynamic digital resources 134 throughout their life cycle, providing certified versioning and an explicit characterization of the change impact. Also, importantly, the VMS 102 of the subject disclosure separates the “contract” of the resource owner 136 from the “contract” of the resource users 138, enabling multiple views of the same change, depending on the stakeholders perspective. This enables new approaches to systematic change management that will address concerns of the more advanced IT stakeholders (developers, integrators) as well as the less IT-aware actors (cross-domain stakeholders, business reps, customers, end users) who need to be involved at a different level of technicality, as change impacts the behavior services they consume.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for version management of a resource, comprising:
receiving, from a resource owner, a resource certification request, the resource certification request comprising a resource and a specification corresponding thereto;
determining a version of the resource in accordance with at least one of the corresponding specification and an invariant associated with the resource;
generating a label for the resource in accordance with the determined version and at least one of the corresponding specification and the invariant associated with the resource;
certifying the resource in accordance with the corresponding specification; and
publishing the certified resource to an associated registry;
wherein at least one of the receiving, determining, generating, certifying, and publishing is performed by a computer processor in communication with memory.

2. The method of claim 1, wherein determining a version of the resource further comprises determining a revision of the resource from the group consisting of a major revision, a minor revision, or a micro revision.

3. The method of claim 2, wherein generating a label further comprises generating the label in accordance with the determined revision.

4. The method of claim 3, wherein the specification comprises an internal specification and an external specification.

5. The method of claim 4, wherein the invariant is representative of a set of logical properties that the resource satisfies over its entire life cycle.

6. The method of claim 5, wherein the invariant further includes at least one aspect that all versions of a resource have in common.

7. The method of claim 4, wherein the specification is representative of a logical formula that varies over time, and wherein certifying the resource further comprises determining that the resource satisfies the specification.

8. The method of claim 7, wherein the specification further comprises an abstract description of the resource relating and a use thereof.

9. The method of claim 8, wherein the specification is selected from the group consisting of a document describing an application program interface, a SQL schema for a data set, a formal context free grammar for a source code written in a specific programming language, or an XSD schema for an XML document.

10. The method of claim 1, wherein the resource is at least one of a technical document, a smartphone application, a computer program, a firmware program, or a piece of hardware.

11. A system comprising memory storing instructions for performing the method of claim 1, and a processor in communication with the memory that executes the instructions stored thereon.

12. A computer program product comprising a non-transitory recording medium storing instructions, which are executed by a processor of a computer, which causes the computer to perform the method of claim 1.

13. A system for version management of a resource, comprising:
a server having a processor and memory in communication with the processor; and
a data storage in communication with the processor, the data storage storing a registry of certified resources,
wherein the memory stores instructions which are executed by the processor to:
receive, from a resource owner over a network interface, a resource certification request, the resource certification request comprising a resource and a specification corresponding thereto,
store the resource and the corresponding specification in the data storage,
determine a version of the resource in accordance with at least one of the corresponding specification and an invariant associated with the resource,
generate a label for the resource in accordance with the determined version and at least one of the corresponding specification and the invariant associated with the resource,
certify the resource in accordance with the corresponding specification, and
publish the certified resource to an associated registry.

14. The system of claim 13, wherein the version of the resource is determined in accordance with a revision of the resource from the group consisting of a major revision, a minor revision, or a micro revision, and wherein the label is generated in accordance with the determined revision.

15. The system of claim 14, wherein the specification comprises an internal specification and an external specification, and wherein the external specification further comprises an abstract description of the resource relating and a use thereof.

16. The system of claim 15, wherein the invariant is representative of a set of logical properties that the resource satisfies over its entire life cycle.

17. The system of claim 16, wherein the invariant further includes at least one aspect that all versions of a resource have in common.

18. The system of claim 17, wherein the specification is representative of a logical formula that varies over time, and wherein certifying the resource further comprises determining that the resource satisfies the specification.

19. The system of claim 18, wherein the specification is selected from the group consisting of a document describing an application program interface, a SQL schema for a data set, a formal context free grammar for a source code written in a specific programming language, or an XSD schema for an XML document.

20. The system of claim 19, wherein the resource is at least one of a technical document, a smartphone application, a computer program, a firmware program, or a piece of hardware.

21. A computer-implemented method for managing a version of a resource, the computer-implemented method comprising:
receiving, from a resource owner, a resource certification request, the resource certification request comprising a resource and a specification corresponding thereto;
determining a version of the resource in accordance with at least one of the corresponding specification and an invariant associated with the resource;
determining a revision of the resource from the group consisting of a major revision, a minor revision, or a micro revision, wherein the version of the resource is updated in accordance with the determined revision;
generating a label for the resource in accordance with the determined version and revision, and at least one of the corresponding specification and the invariant associated with the resource;
determining whether the resource satisfies the specification;
certifying the resource in accordance with a determination that the resource satisfies the corresponding specification; and
publishing the certified resource to an associated registry.

22. The method of claim 21, wherein the specification comprises an internal specification and an external specification, and wherein at least one of the internal specification or external specification further comprises an abstract description of the resource relating and a use thereof.

23. The method of claim 22, wherein the invariant is representative of a set of logical properties that the resource satisfies over its entire life cycle, and wherein the invariant further includes at least one aspect that all versions of a resource have in common.

24. The method of claim 23, wherein the specification is selected from the group consisting of a document describing an application program interface, a SQL schema for a data set, a formal context free grammar for a source code written in a specific programming language, or an XSD schema for an XML document.

25. The computer-implemented method of claim 20, wherein the resource is at least one of a technical document, a smartphone application, a computer program, a firmware program, or a piece of hardware.
